(19) United States
(12) Patent Application Publication
(10) Pub. No.: US 2026/0331004 A1
(43) Pub. Date: Oct. 22, 2026

(54) TAPERED SHELF DIVIDER SYSTEM

(71) Applicant: Presence from Innovation, LLC, Hazelwood, MP (US)

(72) Inventor: Kent L. Hanners, St. Charles, MO (US)

(21) Appl. No.: 19/180,268

(22) Filed: Apr. 16, 2025

(51) Int. Cl. G09F 3/20; A47F 5/00

(52) U.S. Cl. CPC G09F 3/208; A47F 5/0093

(57) ABSTRACT

An auto-glide shelving system includes at least one product channel to guide product (such as a beverage or snack) in a linear fashion toward its proximal end. Each of the product channels are separated by a divider. The system further comprising a tapered support member on the divider. The support member is tapered so as to permit more product to fit within a product channel.

### CROSS-REFERENCE TO RELATED APPLICATIONS

None.

### FIELD OF INVENTION

The present invention relates to a system of an auto-glide shelving system with an improved product channel divider design that includes a tapered support member.

### BACKGROUND

It is common practice to provide product display devices and shelving systems to organize and display merchandise and products to consumers. Existing designs of a shelving system use various methods of bringing product forward from the distal end to the proximal end of the shelving system. The existing designs can be supported in either a flat horizontal position or in an inclined position for gravity-fed products. In gravity-fed existing designs, gravity brings a product forward toward the proximal end. The gravity fed designs generally do not use a shelf pusher. Existing designs may use a pull tab (pull string) that can be manually pulled to bring the product forward on the product shelf. In yet other designs, magnets may be used to move products forward toward the proximal end. Some existing designs, such as those in vending machines, use a coil spring to push products forward as product nearest the proximal end is removed. In other existing designs, a sheet coil, or ribbon spring, may be used to force the shelf pusher forward to bring the product forward on the product shelf.

These existing shelving systems may include a product channel or product channels. Some existing designs for a shelving system include a shelf pusher in a product channel on which product can sit. In some of these existing designs, the product channels are separated by a divider. In some designs, the divider does not have any support members that add to the stability of the dividers. In other existing designs, the divider has a support member or support members. However, the support members in existing designs can act to define the width of a product channel, thus limiting the size of product that can be merchandised within the channel. Limiting the size of product that can fit in a channel within a shelving system limits the ability of a merchant to provide a variety of product sizes.

### SUMMARY

The present disclosure relates generally to product display devices for use in storing and merchandizing shelved products. In particular, various embodiments of a product merchandising display unit provide product display devices to organize and merchandise shelved products to consumers. Other product display devices have a plurality of product channels can be arranged adjacent to one another forming a product shelf shelving system.

The present disclosure overcomes the disadvantages and shortcomings with the known product shelving systems. The present disclosure generally relates to an auto-glide shelving system that includes a tapered support member that assists with moving a product toward the proximal end in a substantially linear fashion.

### BRIEF DESCRIPTION OF THE DRAWINGS

FIG. 1 is an isometric view of a shelving system with a shelf pusher at the distal end;

FIG. 2 is a top view of the shelving system of FIG. 1 with the shelf pusher at the proximal end;

FIG. 3 is an isometric view of the dividers and support member of the shelving system of FIG. 1; and

FIG. 4 is a bottom view of a portion of the divider and support member of shelving system of FIG. 1.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the attached drawings. The invention is capable of other embodiments and of being practiced or of being carried out in various ways. Also, it is to be understood that the phraseology and terminology used herein are for the purpose of description and should not be regarded as limiting. For example, the use of “including,” “comprising,” or “having” and variations thereof herein is meant to encompass the items listed thereafter and equivalents thereof as well as additional items.

As used herein, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

In some instances, a shelving system may be used in a merchandising cooler to bring product forward each time an item is purchased. In other instances, a shelving system may be used in grocery stores or other shopping centers to bring product forward ensuring that the product remains visible at the proximal end of the product shelf. For example, a shelving system may be used for, but is not limited to, canned or bottled beverages which easily maneuver along a product channel. In another example, a shelving system may be used for, but not limited to, other canned goods, jarred goods, and other products housed in containers, cylindrical glass or other vessel. In some instances, the product shape may be, but is not limited to, a cylindrical shape, a substantially cylindrical shape, a square or cubic shape, etc.

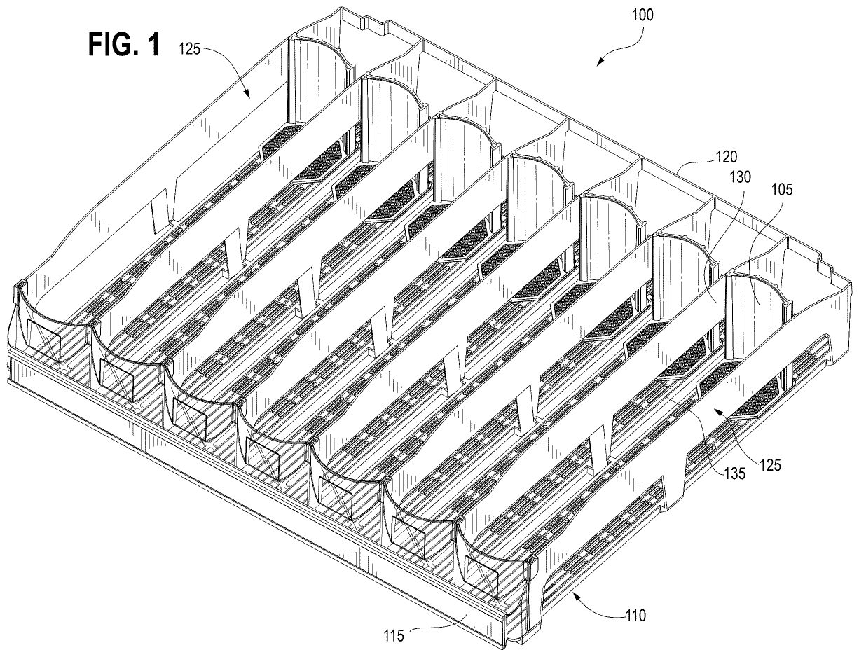

In FIG. 1, an auto-glide shelf 100 (referred to herein as the “shelf 100) is provided. The shelf 100 may include a shelf pusher 105 upon which product can be placed and moved along a shelf floor 110. The shelf floor 110 may include a proximal end 115 and a distal end 120. Product preferably travels from the distal end 120 toward the proximal end 115 as product is selected by a consumer for purchase and/or consumption. FIG. 1 depicts a first configuration of the shelf 100 where the shelf pusher 105 is located near the distal end 120.

The shelf 100 further includes two side wall members 125 that project upwardly from the shelf floor 110 to retain product on the shelf 100 and help prevent it from falling off the shelf 100. Additional divider members 130 may be provided that are positioned and located between the side wall members 125. The divider members 130 preferably define product channels 135 therebetween through which shelf pushers 105 (and products thereon) may slide. The shelf 100 may include a plurality of product channels 135. In this instance, there are seven product channels 135 for dispensing product. In other instances, the product shelf 100 may include more or fewer product channels 135.

In instances where the product channel 135 is stocked with product in a queue, the shelf pusher 105 may start at the distal end 120 of the shelf 100 with a most distal product sitting on the shelf pusher 105 (not illustrated) and at least one product in front of the product on the shelf pusher 105 in a queue-like manner. A fully stocked product queue may stretch from the distal end 120 to the proximal end 115 in the product channel 135, and the shelf pusher 105 is in a most-distal position of the product channel 135.

In other instances when the product in the product queue does not fill up the full length of the product channel 135, the shelf pusher 105 may not start at the most-distal position at the distal end 120 of the shelf 100, but rather somewhere between the distal end 120 and the proximal end 115 of the shelf 100.

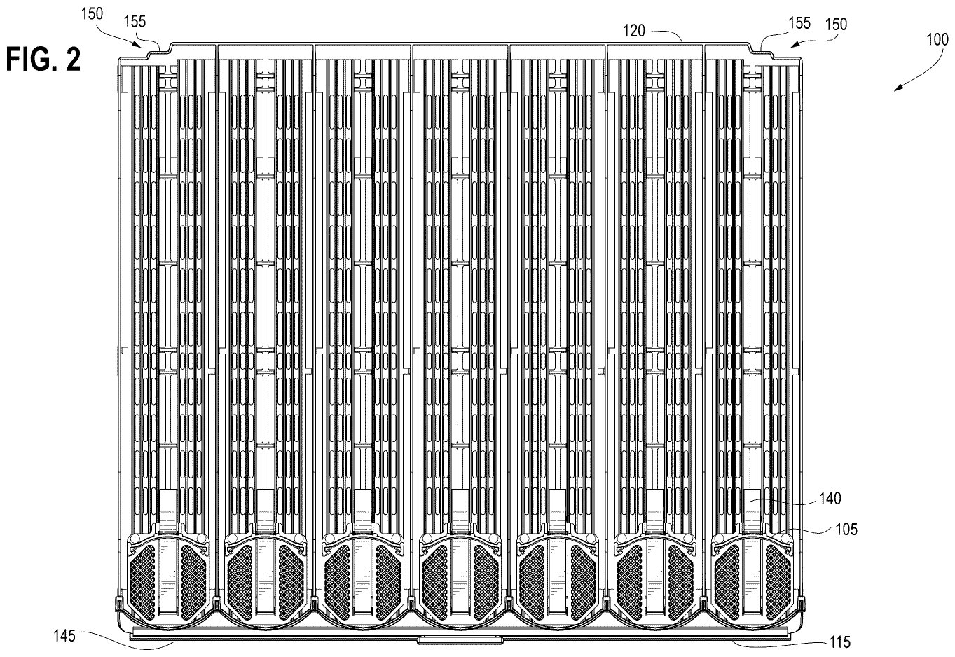

Turning to FIG. 2, As each one of the product(s) is removed from the proximal end 115, a retraction mechanism 140, which may be a coil spring (or other foreseeable mechanism) pushes the shelf pusher 105 (and product thereon and in front thereof) forward from the distal end 120 toward the proximal end 115 of the product shelf 100 until the most-proximal product in the product queue in the product channel 135 reaches a product stop 145 protruding upwardly from the proximal end 115. The front product stop 145 may be either flat or curved. In one instance, for example, the curved front product stop 145 may be designed to mate with cans or bottles.

The shelf 100 may include two cutout portions 150 at its distal end 120 to better allow for the shelf 100 to fit within support systems (not illustrated) like racks, cages, and the like. However, in some embodiments no cutout portions 150 (or one cutout portion 150) may be provided on the shelf 100. Such support systems may include vertical uprights that can extend upwardly through the cutout portions 150. Without the cutout portions 150, such vertical uprights may push the shelf 100 forwardly toward the front of a merchandising structure like a refrigerator, thus preventing the refrigerator door from closing. The cutout portion 150 may also serve as a conduit for electrical, plumbing, and other components to pass through. The cutout portion 150 may be defined by a stairstep pattern 155 in the shelf, though other shapes and patterns, whether polygonal, curved, or otherwise, are also foreseeable.

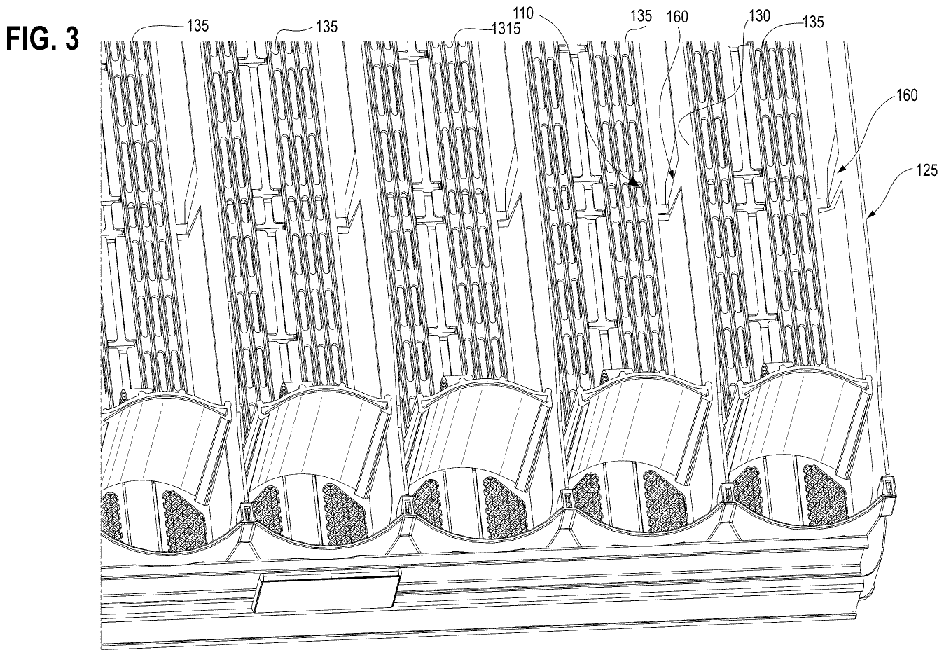

Turning to FIG. 3, the side wall members 125 and divider members 130 that define the product channels 135 may be provided with a support member 160 that projects upwardly from the shelf floor 110 to support and stabilize the side wall members 125 and divider members 130. The support members may be integrally formed with the side wall members 125 and divider members 130, and the shelf floor 110.

In some instances, the support member 160 may be nearer to the distal end 120 of the shelf 100 than to the proximal end 115. In other instances, the support member 160 may be nearer to the proximal end 115 of the shelf 100. In yet other instances, the support member 160 may be centered between the proximal end 115 and the distal end 120, or somewhere else between the proximal end 115 and the distal end 120. In some embodiments, multiple support members 160 may be provided along the length of the side wall members 125 and divider members 130.

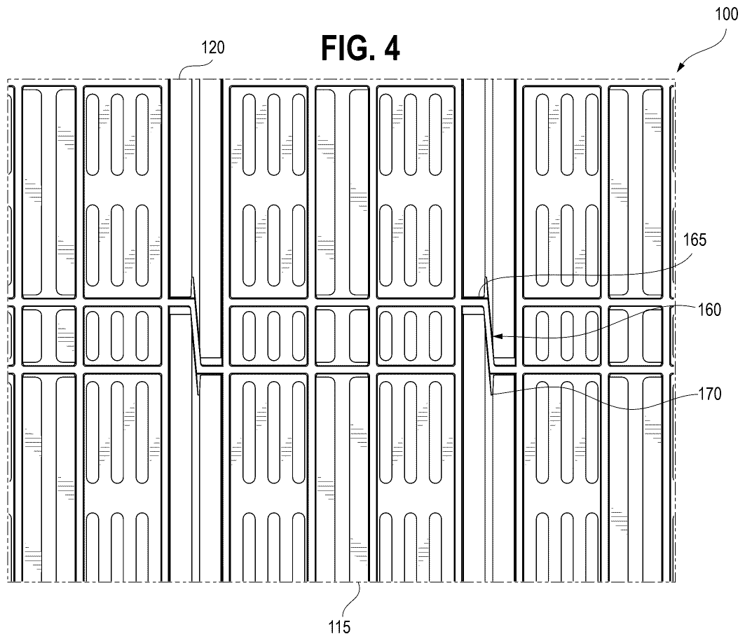

In some instances, the support members 160 may be tapered and/or angled. As provided in FIG. 4 a distal portion 165 of the support members 160 nearer the distal end 120 of the shelf 100 may taper/angle outwardly toward a proximal portion 170 nearer the proximal end 115 of the shelf 100. In alternative embodiments, this may be reversed such that the distal portion 165 tapers inwardly toward the proximal portion 170. Because the support members 160 are tapered/angled, additional product can be supplied within a product channel 135. The tapering and/or angling of the support members 160 may cause product being dispensed on the shelf 100 to move substantially linearly.

In other instances, other configurations are possible. For example, those of skill in the art will recognize, according to the principles and concepts disclosed herein, that various combinations, sub-combinations, and substitutions of the components discussed above can provide appropriate control for a variety of different configurations of auto-glide shelving systems for a variety of applications.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. A shelving system comprising:
a product shelf for supporting at least one product;
at least one product channel to guide an at least one product toward a proximal end of the shelf, wherein each of the at least one product channel is separated from an adjacent at least one product channel by a divider, the divider including a support member extending downwardly to the shelf;
wherein the support member is tapered such that a proximal portion of the support member is offset to a distal portion of the support member.

1. The system of claim 1, wherein a distal end of the shelf includes at least one cutout portion configured to allow a product rack component to pass therethrough.

2. The system of claim 2, wherein the distal end of the shelf includes two cutout portions.

3. The system of claim 2, wherein the at least one cutout portion is formed by a stairstep pattern formed in the shelf.
The system of claim 1, wherein the tapered support member angles outwardly from its distal portion to its proximal portion.

4. The system of claim 1, wherein the support member is between one to three inches long.

5. The system of claim 1, wherein the support member provides for the at least one product to translate substantially linearly along the at least one product channel.

6. A system comprising:
a product shelf for supporting an at least one product;
a product channel guiding the at least one product toward the proximal end;
a shelf pusher that pushes the at least one product toward a proximal end of the product shelf;
a divider for separating a product channel from an adjacent product channel, the divider including a support member for stabilizing the divider; and
wherein the support member is tapered to guide the at least one product toward the proximal end substantially linearly.

7. The system of claim 8, wherein the support member couples the divider to the product shelf.

8. The system of claim 7, wherein the tapered support member includes a proximal portion and a distal portion, and wherein the proximal portion and the distal portion define an acute angle relative to the product channel.

9. The system of claim 7, further comprising a cutout portion formed in the distal end of the shelf for passing equipment therethrough.

10. The system of claim 10, wherein the cutout portion is formed by a stairstep pattern in the distal end of the shelf.

11. The system of claim 10, wherein the distal end of the shelf includes two cutout portions.

12. The system of claim 10, wherein the cutout portion is configured for an upright of a vending rack system to pass therethrough.

13. An auto-glide shelving system comprising:
a product shelf configured to display and dispense at least one product to a consumer;
at least one product channel to guide the at least one product in a linear fashion toward a proximal end of the shelf, wherein each of the at least one product channel is separated by a divider; and
wherein a distal end of the shelf includes a cutout portion configured to pass a piece of equipment therethrough.

1. The system of claim 14, wherein the divider includes a support member for stabilizing the divider.

2. The system of claim 15, wherein the support member is tapered to guide the at least one product toward the proximal end substantially linearly.

3. The system of claim 14, wherein the wherein the cutout portion is formed by a stairstep pattern in the distal end of the shelf.

4. The system of claim 14, wherein the distal end of the shelf includes two cutout portions.

5. The system of claim 14, wherein the support member couples the divider to the product shelf.

6. The system of claim 16, wherein the tapered support member includes a proximal portion and a distal portion, and wherein the proximal portion and the distal portion define an acute angle relative to the product channel.
